(19) United States
(12) Patent Application Publication
(10) Pub. No.: US 2008/0238912 A1
(43) Pub. Date: Oct. 2, 2008

(54) ELECTRO OPTICAL DEVICE, DRIVING METHOD THEREOF, AND ELECTRONIC APPARATUS

(75) Inventor: Toru AOKI, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/033,488

(22) Filed: Feb. 19, 2008

(30) Foreign Application Priority Data
Mar. 28, 2007 (JP) 2007-083697

(51) Int. Cl. G09G 5/00

(52) U.S. Cl. 345/215

(57) ABSTRACT

A driving method of an electro optical device includes pre-charging “m” columns of data lines belonging to each block to at least two different voltages before selecting the block. In addition, the combination of the at least two different voltages pre-charged to the “m” columns of data lines belonging to each block is switched each time a scanning line is selected.

### BACKGROUND

1. Technical Field

The present invention relates to a technique for obscuring deterioration of display quality when so called phase developed data signals are sampled to data lines.

2. Related Art

In recent years, there have been efforts for realizing a higher definition of display images such as high vision. The higher definition of the display images may be realized by increasing the number of scanning lines and the number of data lines. However, since a frame frequency is fixed, an increase in the number of scanning lines may shorten one horizontal scanning period and an increase in the number of data lines may shorten a period for selecting the data lines in the dot sequential method. Therefore, when attempting to achieve higher definition, it may not be possible to secure a sufficient time for supplying the data signals to the data lines, thereby making the writing of data to the pixels insufficient.

In order to solve the insufficient writing of data, a phase-developed driving method has been suggested in JP-A 2000-112437 (hereinafter, referred to as Patent Document 1). The phase-developed driving method is a method in which every predetermined number, for example, three, of data lines are blocked together, and each block are selected in one horizontal scanning period, and the three data lines belonging to the selected block are respectively supplied with data signals which are elongated by three times in the time axis direction. In the phase-developed driving method, since the time for supplying the data signals to the data lines is increased by three times in the example as compared with the dot sequential method, the phase-developed driving method is considered to be suitable for higher-definition display.

Incidentally, in the phase-developed driving method, a vertical stripe pattern in which the gradation of pixels is changed at a cycle of column number selected at the same time is occurred, and there is a case in that the deterioration of display quality is reduced. Consequently, a technique is disclosed in which pre-charge electric potentials of the data lines of three columns are set to different electric potentials before the data signal of the voltage in accordance with gradation is sampled (see JP-A-2002-221476 (hereinafter, referred to as Patent Document 2)).

Note that the both Patent Document 1 and Patent Document 2 show the case in which the number of the data lines constituting one block is “six”.

However, in the technique for setting the pre-charge voltages to different values, there is a problem in that the adjustment of the voltages is difficult and it is difficult to cope with the fluctuation of the element property caused by temperature change or secular change after adjusting the voltages.

### SUMMARY

An advantage of some aspects of the invention is to provide an electro optical device which makes it possible to restrain display unevenness while providing simplification of the adjustment of pre-charge voltages in the case of employing a phase developed driving method, a driving method thereof, and an electronic apparatus.

According to an aspect of the invention, there is provided a driving method of an electro optical device including rows of scanning lines, “m” image signal lines to which a data signal is supplied, columns of data lines blocked into blocks of “m” columns that correspond to the “m” image signal lines, a scanning line driving circuit that applies a selection voltage for a period to one scanning line at a time in a predetermined order to select each scanning line in the predetermined order, a block selecting circuit that selects the blocks of “m” columns in a predetermined order over the period in which the selection voltage is applied to one of the scanning lines, sampling switches provided to each of the columns of data lines, each of the sampling switches controlling electrical connection between the corresponding image signal line and data line, and pixels corresponding to intersections of the rows of scanning lines and the columns of data lines, each pixel is set to a gradation corresponding to a data signal sampled to the data line when the selection voltage is applied to the scanning line. The driving method includes pre-charging the “m” columns of data lines belonging to each block to at least two different voltages before selecting the block, and switching the combination of the at least two different voltages pre-charged to the “m” columns of data lines belonging to each block each time a scanning line is selected. Accordingly, the occurrence of the display unevenness in the longitudinal direction can be restrained.

According to another aspect of the invention, rotation may be performed to the combination of the voltages pre-charged to the m columns of data lines in a predetermined order for each time the scanning line is selected. Further, the rotation may be performed for ever frame. According to the another aspect, display unevenness is further restrained as the display unevenness is dispersed in the time direction and luminance difference is equalized when a plurality of frames are regarded as a unit.

It should be noted here that the “frame” denotes one image to be displayed, for example, an image displayed by vertical scanning in the case of a non-interlace system. Further, an electro optical device and an electronic apparatus having the electro optical device are also included in the invention in addition to the driving method of an electro optical device.

### BRIEF DESCRIPTION OF THE DRAWINGS

The invention will be described with reference to the accompanying drawings, wherein like numbers reference like elements.

FIG. 1 is a block diagram showing a structure of an electro optical device according to an embodiment of the invention.

FIG. 2 is a diagram showing a structure of pixels of the electro optical device.

FIG. 3 is a diagram showing a structure of a control circuit of the electro optical device.

FIG. 4 is a diagram showing switching patterns of a selector of the control circuit.

FIG. 5 is a timing chart for illustrating a display operation of the electro optical device.

FIG. 6 is a timing chart for illustrating a display operation of the electro optical device.

FIG. 7 is a timing char for illustrating a display operation of the electro optical device.

FIG. 8 is a diagram showing an improvement of display unevenness in the electro optical device.

FIG. 9 is a diagram showing an operation according to an application of the electro optical device.

FIGS. 10A, 10B and 10C are each a diagram showing an improvement of display unevenness in the application.

FIG. 11 is a diagram showing a configuration of a projector to which the electro optical device according to the embodiment is applied.

### DESCRIPTION OF EXEMPLARY EMBODIMENTS

Hereinafter, an embodiment of the invention will be described with reference to the accompanying drawings.

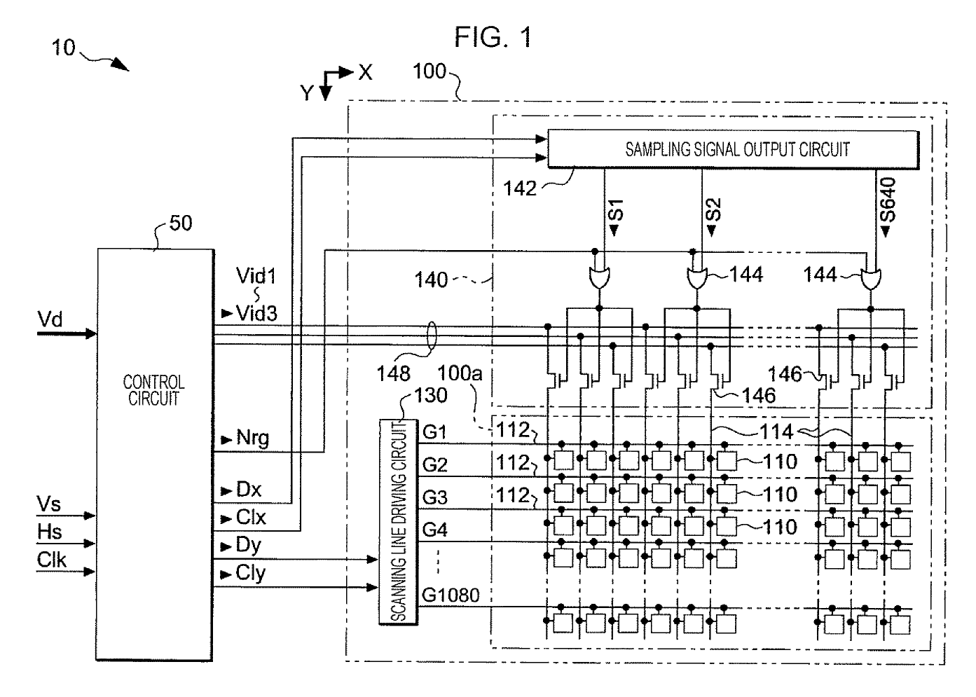

FIG. 1 is a block diagram showing the whole structure of an electro optical device according to the embodiment. As shown in FIG. 1, the electro optical device 10 is roughly divided into a control circuit 50 and a display panel 100. The control circuit 50 is a circuit module independent from the display panel 100 and connected to the display panel 100 by, for example, an FPC (flexible printed circuit) substrate.

The control circuit 50 controls each unit of the display panel 100 in accordance with a vertical synchronization signal Vs, horizontal synchronization signal Hs, and a clock signal Clk supplied from an exterior upper-level circuit (not shown) and supplies data signals converted to three channels of analog from image data Vd of digital or supplies signals for pre-charge of three channel to image signal lines 148 of the display panel 100.

Note that the detail of the control circuit 50 will be described below.

The display panel 100 performs a predetermined display by using liquid crystal. The display panel 100 is a built in type in which periphery circuits, a scanning line driving circuit 130 and a data line driving circuit 140, are arranged around a viewing area 100a.

The viewing area 100a is an area in which pixels 110 are arranged. In the embodiment, 1080 rows of scanning lines 112 are provided in a horizontal direction (X direction), on the other hand, 1920 (=640×3) columns of data lines 114 are provided in a longitudinal direction (Y direction) as shown in FIG. 1. Then, a pixel 110 is respectively provided so as to correspond to each of the crossing points of the scanning lines 112 and the data lines 114. Accordingly, in the embodiment, the pixels 110 are arranged in a matrix manner, 1080 rows in the longitudinal direction×1960 columns in the horizontal direction, in the viewing area 100a. However the invention is not limited to the arrangement.

Herein, the data lines 114 of 1 to 1920 columns are blocked for every three columns in the embodiment. The number of the blocks is “640” as the number of the columns of the data lines 114 is “1920”.

The scanning line driving circuit 130 supplies scanning signals G1, G2, G3, . . . , G1080 respectively to the scanning lines 112 of, 1st, 2nd, 3rd, . . . , 1080th rows over a vertical scanning period (frame). Specifically, the scanning line driving circuit 130 selects the scanning line 112 for every horizontal scanning period (H) in the order of 1st, 2nd, 3rd, . . . , 1080th rows from the top in FIG. 1 and sets the scanning signal for the selected scanning line to H level corresponding to the voltage Vdd only in a valid display period Ha among the horizontal scanning period (H).

There is no direct relation between the structure of the scanning line driving circuit 130 and the invention, so that the description of the structure thereof will be omitted. In the scanning line driving circuit 130, a start pulse Dy supplied from the control circuit 50 is sequentially shifted for each time the level of a clock signal Cly is shifted (risen up or fallen down), and thereafter the pulse width is narrowed to be output as the scanning signals G1, G2, G3, . . . , G1080 as shown in FIG. 5.

Note that, the scanning signal supplied to the selected scanning line may be set to H level over the whole horizontal scanning period (H) without narrowing the pulse width.

The data line driving circuit 140 is constituted by a sampling signal output circuit 142, OR circuits 144 provided for every block, n channel type thin film transistors (hereinafter, referred to as “TFT”) 146 provided so as to correspond to each data line 114.

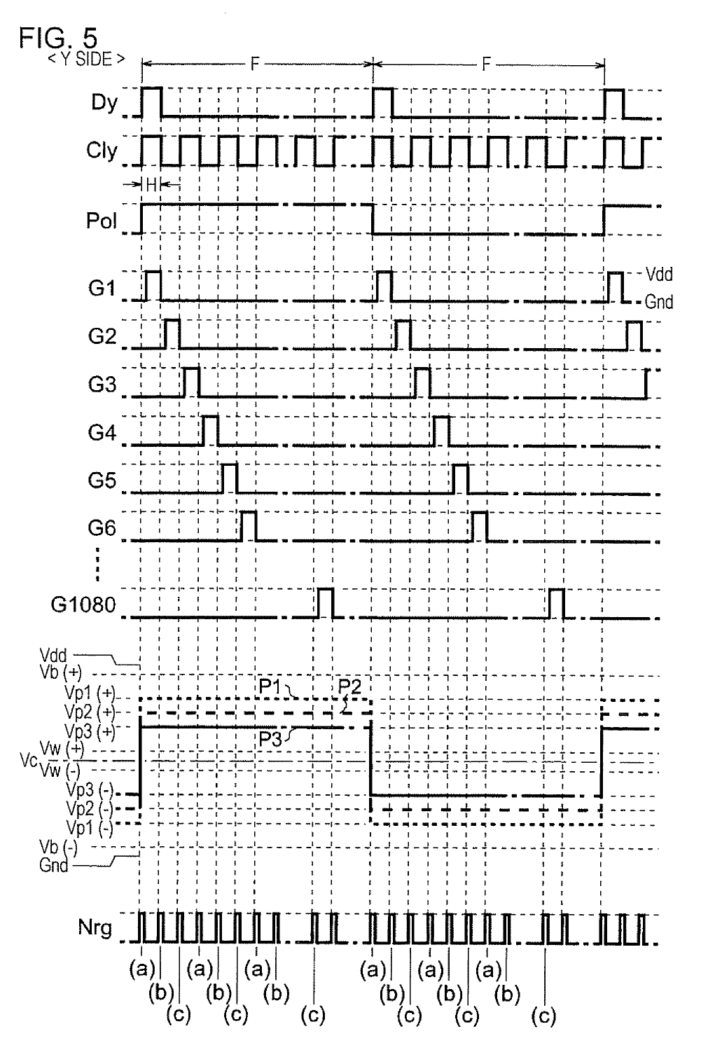

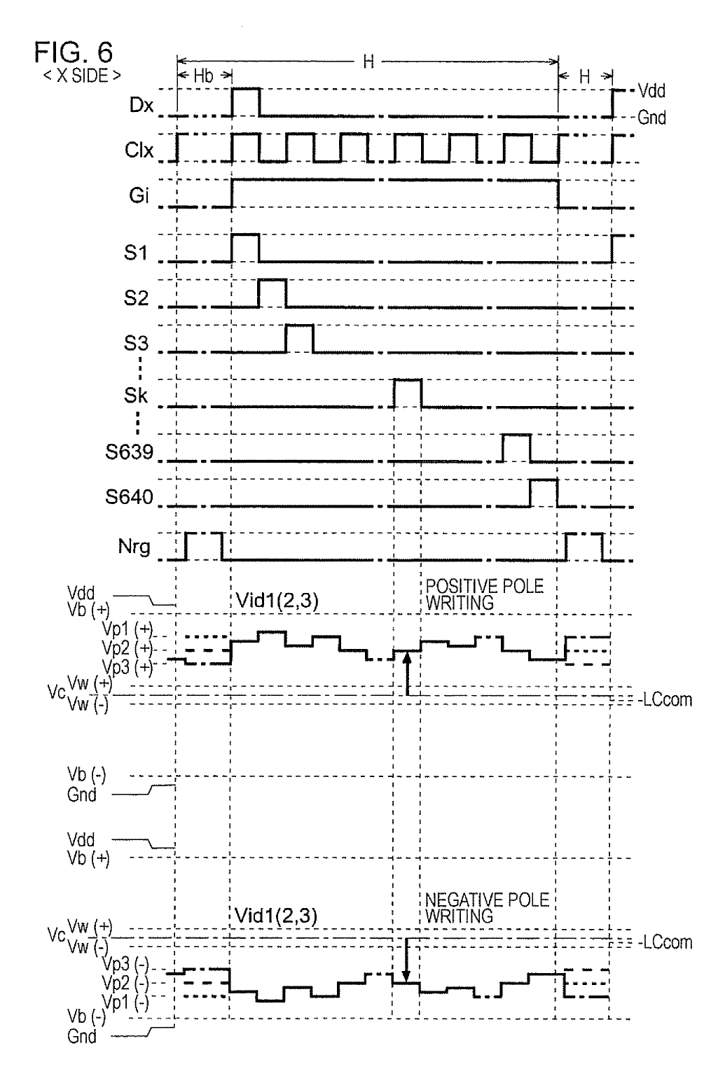

The sampling signal output circuit (block selecting circuit) 142 outputs sampling signals S1, S2, S3, . . , S640 to correspond to each block according to the control by the control circuit 50. Specifically, the sampling signal output circuit 142 sequentially shifts a start pulse Dx supplied at the beginning of the valid display period Ha among the horizontal scanning terminal (H) for each time the level of the clock signal Clx is shifted to output the shifted start pulse Dx as sampling signals S1, S2, S3, . . . , S640 as shown in FIG. 6.

OR circuit 144 outputs a logical sum signal of a sampling signal and a signal Nrg. Herein, the signal Nrg is set to H level during a blanking period Hb of the horizontal scanning period and is a signal for specifying pre-charge to the data line 114.

The TFT 146 is provided to each of the data lines 114 of 1 to 1920 rows and each thereof functions as a sampling switch. The drain electrode thereof is connected to one end of the data line 114.

Herein, the source electrode of the TFT 146 is connected to any one of the three image signal lines 148 by the relation described below. That is, in order to generally describe the data lines 114, if the integer j which satisfies 1≦j≦1920 is used, the source electrode of the TFT 146 corresponding to the data line 114 of jth column from the left side in FIG. 1 is connected to the image signal line 148 to which the data signal Vid1 is supplied when the remainder of j which is the column number is divided by three is “1”, and the source electrode of the TFT 146 corresponding to the data line 114 of jth column whose remainder of j divided by three is “2”, “0” is respectively connected to the image signal line 148 to which the data signal Vid2, Vid3 is supplied. For example, the source electrode of the TFT 146 corresponding to the data line 114 of 8th column from the left is connected to the image signal line 148 to which the data signal Vid2 is supplied as the remainder of “8” divided by three is “2”.

Further, the gate electrodes of the TFT 146 which are belonging to the same block are commonly connected to each other and a logical sum signal output from the OR circuit 144 corresponding to the block is supplied to the gate electrodes. For example, the 2nd block from the left side corresponds to the data lines 114 of 4th, 5th and 6th columns, so that a logical sum signal of the sampling signal S2 and the signal Nrg are commonly supplied to the gate electrodes of the TFT's 146 corresponding to the data lines. Consequently, each of data lines 114 of the three columns belonging to the block is connected the corresponding one of the image signal lines 148 when the signal Nrg is set to H level or when the sampling signal is set to H level as the TFT 146 becomes a conductive (on) state between the source electrode and the drain electrode.

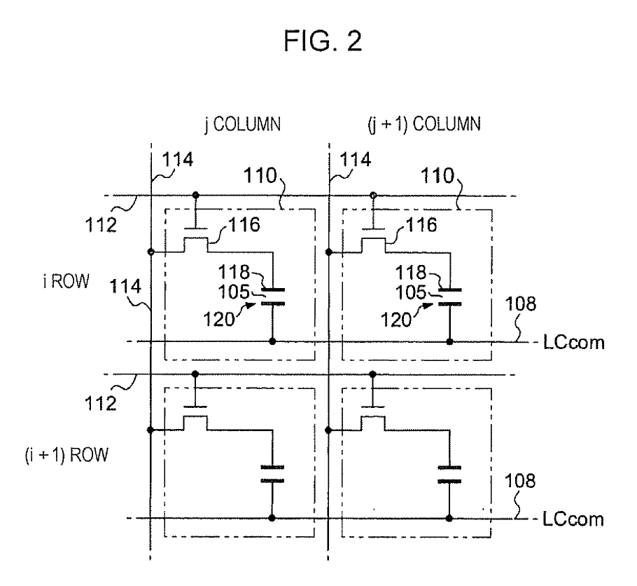

Next, the pixels 110 will be described. FIG. 2 is a diagram showing a structure of the pixels 110. In FIG. 2, four pixels of 2×2 corresponding to the crossing points of i row and (i+1) row adjacent thereto in the lower direction and j column and (j+1) column adjacent thereto in the right direction are shown. Note that i and (i+1) are codes generally showing rows in which the pixels 110 are aligned and are integers which satisfy not less than 1 and not more than 1080.

As shown in FIG. 2, each pixel 110 includes an n channel type TFT 116 and a liquid crystal capacity 120. Since each pixel 110 has the same structure for each other, the pixel 110 positioned at i row j column will be described as a representation. In the pixel of the ith row jth column, the gate electrode of the TFT 116 is connected to the scanning line 112 of the ith row. On the other hand, the source electrode of the TFT 116 is connected to the data line 114 of jth column and the drain electrode thereof is connected to the pixel electrode 118.

Herein, a counter electrode 108 is commonly provided to the whole pixels so as to oppose to the pixel electrodes 118 and is held to a constant voltage LCcom. Then, liquid crystal 105 is sandwiched between the pixel electrodes 118 and the counter electrode 108. Accordingly, the liquid crystal capacitor 120 formed by the pixel electrode 118, the counter electrode 108, and the liquid crystal 105 is constituted for every pixel.

Although not particularly shown in FIG. 2, an alignment layer subjected to a rubbing process is provided to each opposing surface of the both substrates so that the long axis direction of the liquid crystal molecules are continuously twisted by, for example, about 90 degrees between the both substrates. On the other hand, a polarizer arranged in the alignment direction is provided to each back surface side of the both substrates.

The light passing between the pixel electrodes 118 and the counter substrate 108 is optically rotated along the twist of the liquid crystal molecules by about 90 degrees when the active value of the voltage held by the liquid crystal capacitor 120 is zero (or near zero). On the other hand, as the magnitude of the voltage effective value becomes larger, the liquid crystal molecules are inclined in the electric field direction. As a result, the optical rotation property disappears. Consequently, for example, in the transmission type, when the polarizers whose polarization axes are perpendicular to each other are arranged at the incident side and the back surface side so as to coincident with the alignment directions, when the voltage effective value is near zero, white color is displayed by the maximum light transmittance. On the other hand, the transmitted light intensity is decreased as the voltage effective value becomes larger, and eventually, black color is displayed by the minimum light transmittance (normally white mode).

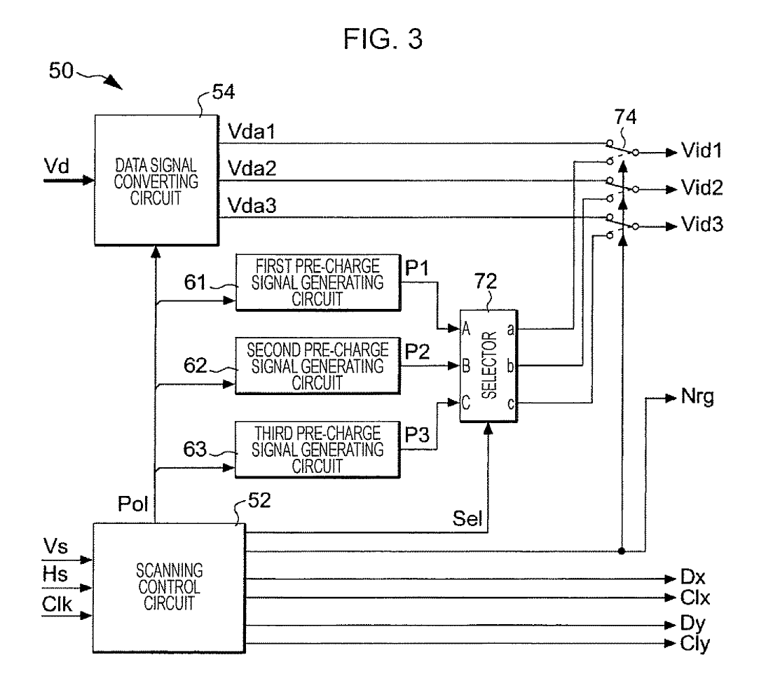

Subsequently, the control circuit 50 will be described. FIG. 3 is a block diagram showing a structure of the control circuit 50.

As shown in FIG. 3, an image data Vd is supplied to a data signal converting circuit 54. The image data Vd is supplied in synchronization with the vertical scanning signal Vs, the horizontal scanning signal Hs, and the clock signal Clk from the exterior upper-level circuit. The image data Vd is digital data indicating the gradation of the pixels 110 of 1080 rows in the longitudinal direction×1920 columns in the horizontal direction by, for example, 8 bits. Although not particularly shown in FIG. 3, the image data Vd is supplied in rotation of the pixels 110 of 1 row 1 column to 1 row 1920 column, 2 row 1 column to 2 row 1920 column, 3 row 1 column to 3 row 1920 column, . . . , 1080 row 1 column to 1080 row 1920 column over a vertical scanning period (F) set by the vertical synchronization signal Vs. When image data Vd is supplied, the image data Vd for one row is supplied during the horizontal scanning period (H) set by the horizontal synchronization signal Hs and the image data Vd for one pixel is supplied during one cycle of the clock signal Clk.

The scanning control circuit 52 outputs start pulse Dx, Dy and cock signals Clx, Cly in synchronization with the vertical synchronization signal Vs, the horizontal synchronization signal Hs, and the clock signal Clk.

Specifically, the scanning control circuit 52 outputs the start pulse Dy and the clock signal Cly to control the scanning line driving circuit 130 so that the scanning line 112 of 1st row is selected during the horizontal canning period (H) in which the image data vd of 1st row is supplied, and in a similar way, the scanning lines 112 of 2nd, 3rd, 4th, . . . , 1080th row are respectively selected during the horizontal scanning period (H) in which the image data Vd for 2nd, 3rd, 4th, . . . , 1080th is supplied.

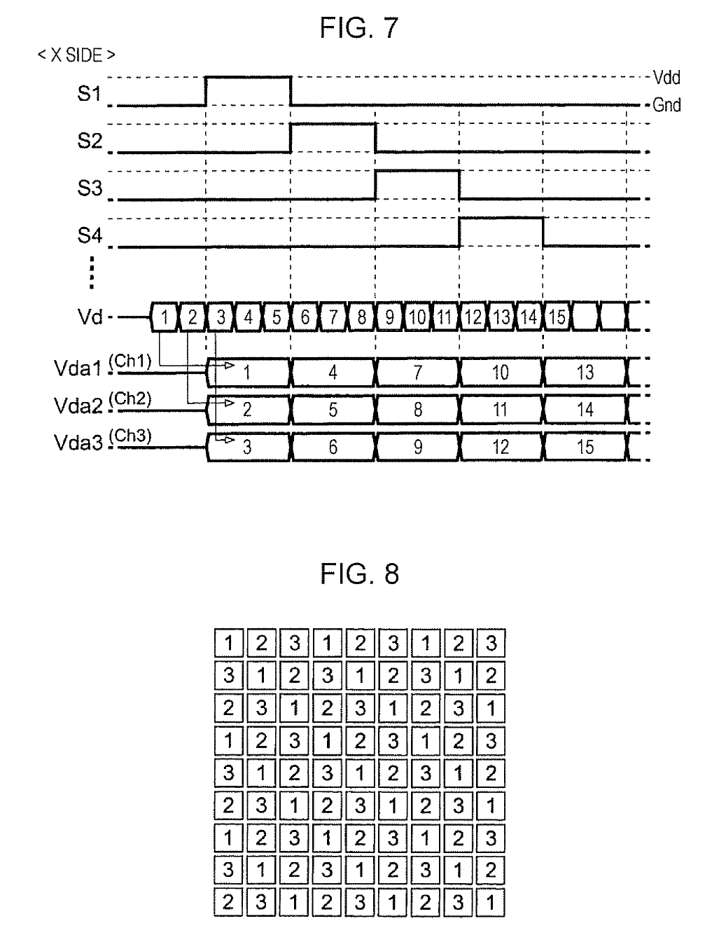

Further, the scanning control circuit 52 controls the data signal converting circuit 54 to perform phase development process for distributing the image data vd to three channels and extending the distributed data by triple in the time axis direction as shown in FIG. 7 when the image data Vd corresponding to a row is supplied in the horizontal scanning period (H) in which a scanning line 112 of the row is selected. Further, the scanning control circuit 52 controls the image data subjected to the phase development process to be converted to data signals Vda1, Vda2, Vda3 having positive polarity voltages or negative polarity voltages.

It should be noted here that there is a case in which the channel to which the data signal Vda1 is distributed is described as Ch1, and the channel to which the data signal Vda2, Vda3 is distributed is respectively described as Ch2, ch3.

In this case, the scanning control circuit 52 outputs the start pulse Dx and the clock signal Clx to control the sampling signal output circuit 142 so that the sampling signal S1 is set to H level when the data signal Vda1 (Vda2, Vda3) corresponding to the pixel of 1st (2nd, 3rd) column is output and the sampling signals S2, S3, S4, . . . , S640 are set to H level when the data signal Vda1 (Vda2, Vda3) corresponding to the pixel of 4th (5th, 6th) column, 7th (8th, 9th) column, 10th (11th, 12th) column, . . . , and 1918th (1919th, 1920th) columns are output.

The scanning control circuit 52 also outputs a pole specification signal Pol, a signal Nrg and a signal Sel. The pole specification signal Pol is a signal for specifying writing polarity of the voltage with respect to the liquid crystal capacity 120 and, for example, specifies positive polarity when H level and specifies negative polarity when L level respectively. Herein, the positive polarity writing means that the pixel electrode 118 is set to the high electric potential side than the counter electrode 108, and on the other hand, the negative polarity writing means that the pixel electrode 118 is set to the low electric potential side than the counter electrode 108 when the liquid crystal capacity 120 is hold to the voltage in accordance with the gradation. The data signal converting circuit 54 sets the data signals Vda1, Vda2, Vda3, to the voltage in accordance with the gradation and higher than the reference voltage Vc (see FIG. 6) set slightly higher than the voltage LCcom applied to the counter electrode 108 when positive polarity writing is specified and lower than the voltage Vc when negative polarity writing is specified.

Note that the reason for switching the polarity is to prevent deterioration of the liquid crystal caused by application of direct current component. Herein, various aspects may be available as for switching of the polarity when writing to each pixel. For example, the polarity may be switched for every scanning line, for every data line, for every pixel, for every surface (frame). In the embodiment, for the sake of convenience of the description, the polarity shall be reversed for every frame. However, the invention is not limited to the embodiment.

The signal Nrg is a signal for specifying pre-charge to the data line 114 as described above. As shown in FIG. 5, the signal Nrg is set to H level during the horizontal blanking period Hb (a part of period) and set to L level during the rest of the period.

The signal Sel sets the connection relationship of input and output terminals of the selector described below.

Note that in the description, the valid display period Ha of the horizontal scanning period (H) denotes the period during the sampling signals S1 to S640 are sequentially output at H level in the horizontal scanning period (H) in which the scanning line of a raw is selected and the blanking period Hb denotes the period during the rest of the horizontal scanning period (H) except the valid display period Ha.

The first pre-charge generating circuit 61 outputs signal P1 having a voltage in accordance with the writing polarity specified by the polarity specification signal Pol. Similarly, the second pre-charge generating circuit 62 and the third pre-charge generating circuit 63 respectively outputs signal P2, P3 having a voltage in accordance with the writing polarity specified by the polarity specification signal Pol.

The voltage wave shapes of the signals P1, P2, P3 will be described with reference to FIG. 5. As shown in FIG. 5, the signal P1 is set to the voltage Vp1(+) during the vertical scanning period (F) in which positive polarity writing is specified and set to the voltage Vp1(−) during the vertical scanning period (F) in which negative polarity writing is specified. Similarly, the signals P2, P3 are set to the voltage Vp2(+), Vp3(+) during the vertical scanning period (F) in which positive polarity writing is specified and set to the voltage Vp2(−), Vp3(−) during the vertical scanning period (F) in which negative polarity writing is specified.

Note that the voltages of the data signals Vda1 to Vda3 are set to the voltages respectively having a difference from the voltage Vc in accordance with the gradation of the pixel in the range from the voltage Vb(+) corresponding to the most dark state to the voltage Vw(+) corresponding to the most bright state when positive polarity writing is specified or in the range from the voltage Vb(−) corresponding to the most dark state to the voltage Vw(−) corresponding to the most bright state when negative polarity writing is specified in a normally white mode. The voltages Vp1(+), Vp2(+), Vp3(+) satisfy the relation of Vb(+)>Vp1(+)>Vp2(+)>Vp3(+)>Vw(+) and the voltages Vp1(−), Vp2(−), Vp3(−) satisfy the relation of Vb(−)<Vp1(−)<Vp2(−) <Vp3(−)<Vw(−) in such a voltage range.

In the description of the voltages, (+) denotes positive polarity and (−) denotes negative polarity.

Accordingly, the groups of voltages having the same polarity have a symmetric relationship with respect to the voltage Vc.

Further, the longitudinal scale showing the voltages of the signal P1, P2, P3 is enlarged as comparer with the voltage wave shapes of the logic signals such as a scanning signal, a selecting signal, and the like. The longitudinal scale showing the voltage of the data signal in FIG. 6 is also enlarged.

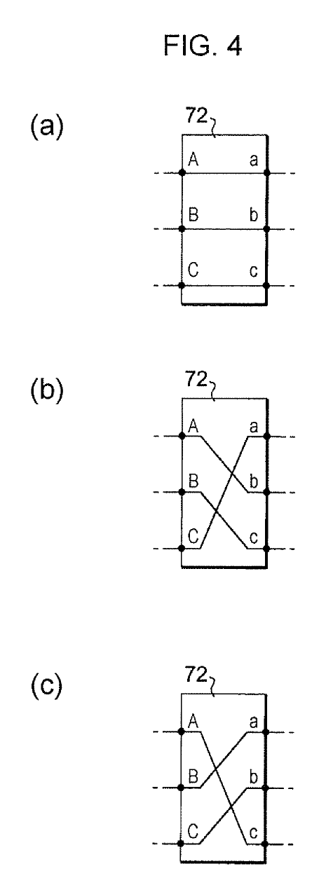

The signals P1, P2, P3 are respectively supplied to the input terminals A, B, C of the selector 72. The selector 72 switches the connection of the input terminals A, B, C and the output terminals a, b, c to the patterns (a), (b), (c) shown in FIG. 4 in rotation in accordance with the signal Sel. Specifically, for example, if the connection state of the input terminal A and the output terminal a is expressed by A-a by using “-”, the connection state of the selector 72 becomes A-a, B-b, C-c in pattern (a), A-b, B-c, C-a in pattern (b), and A-c, B-a, C-b in pattern (c). Then, the selector 72 switches the pattern in the order of (a)→(b)→(c)→(a)→(b)→(c)→. . . a)→(b)→(c) for every horizontal scanning period (H) in which a scanning line 112 of 1, 2, 3, 4, 5, 6, . . . , 1078, 1079, 1080 rows is selected.

The switch group 74 is constituted by three string switches. When the signal Nrg is L level, the switch group 74 is set to the position shown by the solid line in FIG. 3 and the data signals Vda1 to Vda3 are selected. When the signal Nrg is H level, the switch group 74 is set to the position shown by the dotted line in FIG. 3 and the signals output from the selector 72 are selected and respectively output as the data signals Vda1 to Vda3.

Next, the operation of the electro optical device 10 will be described.

As described above, the image data Vd is supplied in the order of the pixels of 1 row 1 column to 1 row 1920 column, 2 row 1 column to 2 row 1920 column, 3 row 1 column to 3 row 1920 column, . . . , 1080 row 1 column to 1080 row 1920 column over the vertical scanning period (F) set by the vertical synchronization signal Vs. When the image data Vd is supplied, the image data Vd for one row is supplied in the horizontal scanning period (H) set by the horizontal synchronization signal Hs. Further, the image data Vd for one pixel is supplied in one cycle of the clock signal Clk.

The scanning control circuit 52 controls the data signal converting circuit 54, the scanning line driving circuit 130, and the data lined driving circuit 140 as described below as for one row of the image data vd supplied in such a manner. That is the scanning control circuit 52 controls the data signal converting circuit 54 so that the image data Vd corresponding to the pixel of 1, 4, 7, 10, . . . , 1918 column is distributed to the channel ch1, corresponding to the pixel of 2, 5, 8, 11, . . . , 1919 column is distributed to the channel ch2, and corresponding to the pixel of 3, 6, 9, 12, . . . , 1920 column is distributed to the channel ch3 and controls the scanning line driving circuit 130 so that the scanning signal corresponding to the row to which the image data Vd is supplied is set to H level.

Further, the scanning control circuit 52 controls the sampling signal output circuit 142 so that the sampling signal S1 is set to H level during the image data Vd corresponding to the pixels of 1 to 3 columns respectively distributed to the channels Ch1 to Ch3 is converted to the data signals Vid1 to Vid3 to be output, and the sampling signal S2 is set to H level during the image data Vd corresponding to the pixels of 4 to 6 columns is converted to the data signals Vid1 to Vid3 to be output, and similarly, the sampling signal S640 is set to He level during the image data Vd corresponding to the pixels of 1918 to 1920 columns is converted to data signal Vid1 to Vid3 to be output.

In the embodiment, the writing polarity is reversed for each frame as described above. Positive polarity writing shall be specified in a frame (the frame shall be referred to as “n frame”).

In this n frame, first, the signal Nrg is set to H level during the blanking period Hb of the horizontal scanning period (H) in which the scanning line 112 of 1st row is selected.

The signals P1, P2, P3 are respectively set to the voltages Vp1(+), Vp2(+), Vp3(+) having positive polarity. The selector 72 is set to the connection shown by the pattern (a) in FIG. 4 during the horizontal scanning period (H) in which the scanning line 112 of 1st row is selected. When the signal Nrg is set to H level, the switch group 74 is set to the position shown by the dotted line in FIG. 3. Consequently, the data signals Vid1, Vid2, Vid3 supplied to the image signal lines 148 are respectively set to the signals P1, P2, P3. When the signal Nrg is set to H level, the output signals of the all of the OR circuits 144 are set to H level independently from the sampling signals, so that all of the TFT's 146 of 1 to 1920 columns are set to on.

Accordingly, the data lines 114 of 1, 4, 7, 10, 1918 columns are pre-charged to the voltage Vp1(+) of the signal P1, and the data lines 114 of 2, 5, 8, 11, . . . , 1919 columns are pre-charged to the voltage Vp2(+) of the signal P2, and the data lines 114 of 3, 6, 9, 12, . . . , 1920 columns are pre-charged to the voltage Vp3(+) of the signal P3.

After the data lines 114 are pre-charged, the signal Nrg is set to L level and the blanking period Hb is finished.

When the signal Nrg is set to L level, the switch group 74 is set to the position shown by the solid line in FIG. 3. Consequently, the data signals Vid1, Vda2, Vid3 supplied to the image signal lines 148 are respectively set to data signals Vda1, Vda2, Vda3 output form the data signal converting circuit 54. Further, when the signal Nrg is set to L level, the logical sum signal output from the OR circuit 144 is set to the same logic as the sampling signal.

Next, the scanning signal G1 is set to H level and the valid display period Ha is started.

First, when the scanning signal G1 is set to He level, the pixels 110 positioned in the 1st row, that is, the TFT's 116 of 1 row 1 column to 1 row 1920 column are set to on. In the valid display period Ha in which the scanning signal G1 is set to H level, first, the sampling signal S1 is set to H level. Specifically, the sampling signal S1 is set to H level during the data signals Vid1, Vid2, Vid3 supplied to the three image signal lines 148 are respectively set to the positive polarity voltages corresponding to the gradations of the pixels of the 1 row 1 column, 1 row 2 column, 1 row 3 column.

When the sampling signal S1 is set to H level, the TFT's 146 of 1, 2, 3 columns belonging to the 1st block are set to on. Consequently, the data signals Vid1, Vid2, Vid3 supplied to the three image signal lines 148 are sampled to the data lines 114 of the 1st column, 2nd column, 3rd column, so that positive polarity voltages corresponding to the gradations are respectively applied to the pixel electrodes 118 of 1 row 1 column, 1 row 2 column, 1 row 3 column via the on state TFT's 116.

Next, the sampling signal S2 is set to H level during the data signals Vid1, Vid2, Vid3 are respectively set to the positive polarity voltages corresponding to the gradations of the pixels of 1 row 4 column, 1 row 5 column, 1 row 6 column. When the sampling signal S2 is set to H level, the TFT's 146 of 4, 5, 6 columns belonging to the second block are set to on. Consequently, the data signals Vid1, Vid2, Vid are sampled to the data lines 114 of 4th column, 5th column, 6th column, so that the positive polarity voltages corresponding to the gradations are respectively applied to the pixel electrodes 118 of 1 row 4 column, 1 row 5 column, 1 row 6 column.

Subsequently, in a similar way, when the sampling signals S3, S4, . . . , S640 are sequentially set to H level, the data signals Vid1 to Vid3 are respectively sampled to the data lines 114 of three columns belonging to the 3rd, 4th, . . . , 640th block in rotation. Herewith, positive polarity writing in accordance with the gradation is performed to the pixels of 1 to 1920 columns positioned in the 1st row.

Subsequently, the scanning line 112 of the 2nd row is selected.

The signal Nrg is set to H level during the blanking period Hb of the horizontal scanning period (H) in which the scanning line 112 of the 2nd row is selected. Herein, the voltages Vp1(+), Vp2(+), Vp3(+) of the signals P1, P2, P3 having positive polarity during the horizontal scanning period (H) in which the scanning line 112 of the 1st row is selected are not changed. However, the selector 72 is set to the connection shown by the pattern (b) of FIG. 4 during the horizontal scanning period (H) in which the scanning line 112 of the 2nd row is selected. Consequently, when the signal Nrg is set to H level, the data signals Vid1, Vid2, Vid3 supplied to the image signal lines 148 are respectively set to the signals P3, P1, P2.

Accordingly, in the blanking period Hb of the horizontal scanning period (H) in which the scanning line of the 2nd row is selected, the data lines 114 of 1, 4, 7, 10, . . . , 1918 columns corresponding to the channel Ch1 are pre-charged to the voltage Vp3(+) of the signal P3, the data lines 114 of 2, 5, 8, 11, . . . , 1919 columns corresponding to the channel Ch2 are pre-charged to the voltage Vp1(+) of the signal P1, and the data lines 114 of 3, 6, 9, 12, . . . , 1920 columns corresponding to the channel Ch3 are pre-charged to the voltage Vp2(+) of the signal P2.

Note that in the valid display period Ha of the horizontal scanning period (H) in which the scanning line of the 2nd row is selected, the similar operation as that in the 1st row is performed to the pixels 110 of the 2nd row. Herewith, positive polarity writing in accordance with the gradation is performed to the pixels of 1 to 1920 columns positioned in the 2nd row.

Next, the scanning line 112 of the 3rd row is selected.

The signal Nrg is set to H level during the blanking period Hb of the horizontal scanning period (H) in which the scanning line 112 of the 3rd row is selected. The voltages Vp1(+), Vp2(+), Vp3(+) of the signals P1, P2, P3 having positive polarity during the horizontal scanning period (H) in which the scanning lines 112 of the 1st, 2nd rows are selected are not changed. However, the selector 72 is set to the connection shown by the pattern (c) of FIG. 4 during the horizontal scanning period (H) in which the scanning line 112 of the 3rd row is selected. Consequently, when the signal Nrg is set to H level, the data signals Vid1, Vid2, Vid3 supplied to the image signal lines 148 are respectively set to the pre-charge signals P2, P3, P1.

Accordingly, in the blanking period Hb of the horizontal scanning period (H) in which the scanning line 112 of the 3rd row is selected, the data lines 114 corresponding to the cannel ch1 are pre-charged to the voltage Vp2(+) of the signal P2, the data lines 114 corresponding to the cannel ch2 are pre-charged to the voltage Vp3(+) of the signal P3, and the data lines 114 corresponding to the cannel ch3 are pre-charged to the voltage Vp1(+) of the signal P1.

Note that in the valid display period Ha of the horizontal scanning period (H) in which the scanning line of the 3rd row is selected, the similar operation as that in the 1st, 2nd rows is performed to the pixels 110 of the 3rd row. Herewith, positive polarity writing in accordance with the gradation is performed to the pixels of 1 to 1920 columns positioned in the 3rd row.

Subsequently, in a similar way, in the blanking period Hb of the horizontal scanning period (H) in which the scanning lines 112 of 4, 7, 10, . . . , 1078 rows are selected, the data lines 114 corresponding to the channel Ch1 are pre-charged to the voltage vp1(+), the data lines 114 corresponding to the channel Ch2 are pre-charged to the voltage Vp2(+), and the data lines 114 corresponding to the channel Ch3 are pre-charged to the voltage Vp3(+).

Further, in the blanking period Hb of the horizontal scanning period (H) in which the scanning lines 112 of 5, 8, 11, . . . , 1079 rows are selected, the data lines 114 corresponding to the channel Ch1 are pre-charged to the voltage Vp3(+), the data lines 114 corresponding to the channel Ch2 are pre-charged to the voltage Vp1(+), and the data lines 114 corresponding to the channel Ch3 are pre-charged to the voltage Vp2(+).

Further, in the blanking period Hb of the horizontal scanning period (H) in which the scanning lines 112 of 6, 9, 12, . . . , 1080 rows are selected, the data lines 114 corresponding to the channel Ch1 are pre-charged to the voltage Vp2(+), the data lines 114 corresponding to the channel Ch2 are pre-charged to the voltage Vp3(+), and the data lines 114 corresponding to the channel Ch3 are pre-charged to the voltage Vp1(+).

In any case, positive polarity writing in accordance with the gradations of the pixels of the selected row is performed to the pixels of 1 to 1920 columns during the valid display period Ha after the pre-charge

Also in the next (n+1) frame, the similar writing is performed. In the case, the writing polarity to each row is switched to negative polarity from positive polarity. Consequently, the pre-charge signals P1, P2, P3 are respectively set to the voltage Vp1(−), Vp2(−), Vp3(−) having negative polarity, so that the data lines 114 corresponding to the channel Ch1 are pre-charged to the voltage Vp1(−), the data lines 114 corresponding to the channel Ch2 are pre-charged to the voltage Vp2(−), and the data lines 114 corresponding to the channel Ch3 are pre-charged to the voltage Vp3(−) in the blanking period Hb of the horizontal scanning period (H) in which the scanning lines 112 of 1, 4, 7, 10, . . . , 1078 rows are selected.

Further, in the blanking period Hb of the horizontal scanning period (H) in which the scanning lines 112 of 2, 5, 8, 11, . . . , 1079 rows are selected, the data lines 114 corresponding to the channel Ch1 are pre-charged to the voltage Vp3(−), the data lines 114 corresponding to the channel Ch2 are pre-charged to the voltage Vp1(−), and the data lines 114 corresponding to the channel Ch3 are pre-charged to the voltage Vp2 (−).

Further, in the blanking period Hb of the horizontal scanning period (H) in which the scanning lines 112 of 3, 6, 9, 12, . . . , 1080 rows are selected, the data lines 114 corresponding to the channel Ch1 are pre-charged to the voltage Vp2(−), the data lines 114 corresponding to the channel Ch2 are pre-charged to the voltage Vp3(−), and the data line 114 corresponding to the channel Ch3 are pre-charged to the voltage Vp1(−).

In any case, negative polarity writing in accordance with the gradations of the pixels of the selected row is performed to the pixels of 1 to 1920 columns during the valid display period Ha after the pre-charge.

Herewith, in the (n+1) frame, negative polarity writing is performed to the pixels of each row, so that application of direct current component to the liquid crystal can be prevented in each pixel with the positive polarity writing in the n frame.

Note that FIG. 6 is a diagram showing an example of output wave forms of the sampling signals S1 to S640 and the wave forms of the data signal Vid1 (Vid2, Vid3).

The voltage of the data signal Vid1 supplied to the image signal line 148 is set to any one of the signals Vp1(+), Vp2(+), Vp3(+) when the signal Nrg is H level when the positive polarity writing is specified and thereafter changed in synchronization with the sampling signal which is set to H level. Specifically, when the sampling signal Sk corresponding to the Kth block is set to H level, the data signal Vid1 is set to the positive polarity voltage corresponding to the gradation of the pixel of ith row (3K−2)th column as shown by the arrow ↑ in FIG. 6 and when positive polarity writing is specified, and the data signal Vid1 is set to the negative polarity voltage corresponding to the gradation of the pixel of ith row (3K−2)th column shown by the arrow ↓ in FIG. 6 when negative polarity writing is specified.

Incidentally, if there is a difference in converting property in the data signal converting circuit 54 for each channel and if there is a difference in a wiring resistance or a parasitic capacitor in the three image signal lines 148, the voltages of the data signals Vid1 to Vid3 sampled to the data lines 114 are set to different voltages for every channel even when the same gradation is required. Consequently, when the pre-charge voltages are not set to the same value for each channel or when the rotation of the pre-charge voltages is not performed, the voltage sampled to the data line 114 is set to a different voltage for every channel. The difference causes display unevenness in the longitudinal direction along the data line. This is typical display unevenness in the phase development.

On the contrary, in the embodiment, all of the data lines 114 are pre-charged in the blanking period Hb before the voltage in accordance with the gradation is sampled to the data lines 114 in the valid display period Ha. In this regard, the data lines 114 corresponding to the cannel Ch1, Ch2, Ch3, are pre-charged to different voltage for each other and the voltage of pre-charge signal supplied to each channel is switched for every horizontal scanning period.

Herein, the pre-charge voltage sets the initial state right before the voltage in accordance with the gradation is sampled to the data line 114. When the period for sampling the voltage in accordance with the gradation is short, or when the driving capability of the TFT 146 is not sufficient, even when the same voltage is sampled, the initial state becomes different, so that the voltages sampled to the data lines becomes different. However, in the embodiment, the pre-charge voltages of the data lines are switched for each time one row of the scanning line is selected, so that the influence caused by the difference of the pre-charge voltage is sequentially shifted in the horizontal direction for every scanning line as shown in FIG. 8.

Accordingly, in the embodiment, the display unevenness in the horizontal direction caused by sequential shifting is added to the typical display unevenness in the longitudinal direction in the phase development.

Accordingly, the display unevenness in the longitudinal direction and the display unevenness in the horizontal direction are combined to obscure the display unevenness.

In FIG. 8, □ shows a pixel and the numbers 1, 2, 3 in □ shows that the pixel is respectively pre-charged by the signals P1, P2, P3.

Note that elimination of such display unevenness may be also provided by the configuration in which rotation is performed to the combination of the data signals Vid1 to Vid3 and the three image signal lines 148 supplying the data signals. However, the configuration is not realistic as the circuit for sampling the image signal to the data line is complicated.

In the embodiment described above, the pre-charge voltages of the data lines corresponding to the channel Ch1, Ch2, Ch3 are respectively set to the voltages Vp1(+), Vp2(+), Vp3(+) when positive polarity writing is specified and the voltages Vp1(−), Vp2(−), Vp3(−) when negative polarity writing is specified and are fixed values in each frame during the horizontal scanning period in which the scanning line of, for example, the 1st row is selected. However, the voltages may be switched for every frame.

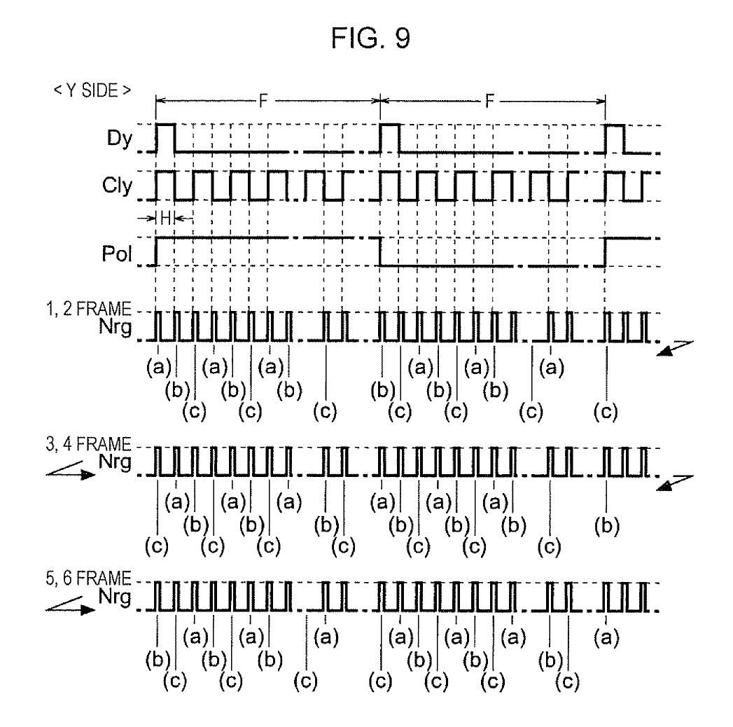

As for the structure for switching the voltages for every frame, for example, the selector 72 may be set to the connection pattern as shown in FIG. 9. That is, if a frame in which positive polarity writing is specified is the 1st frame, the starting position of the connection pattern of the selector 72 is set to (a) pattern in 1st and 4th frames, (b) pattern in 2nd and 5th frames, and (c) pattern in 3rd and 6th frames. In each frame, the pattern is switched in the order of (a)→(b)→(c)→(a)→(b)→(c) in rotation.

When the pattern is switched for every frame in such a manner, positive polarity writing is specified in the odd (1, 3, 5) frames and negative polarity writing is specified in the even (2, 4, 6) frames, so that each of positive polarity writing and negative polarity writing are performed to the frames in which the starting position of the connection pattern are (a),(b),(c).

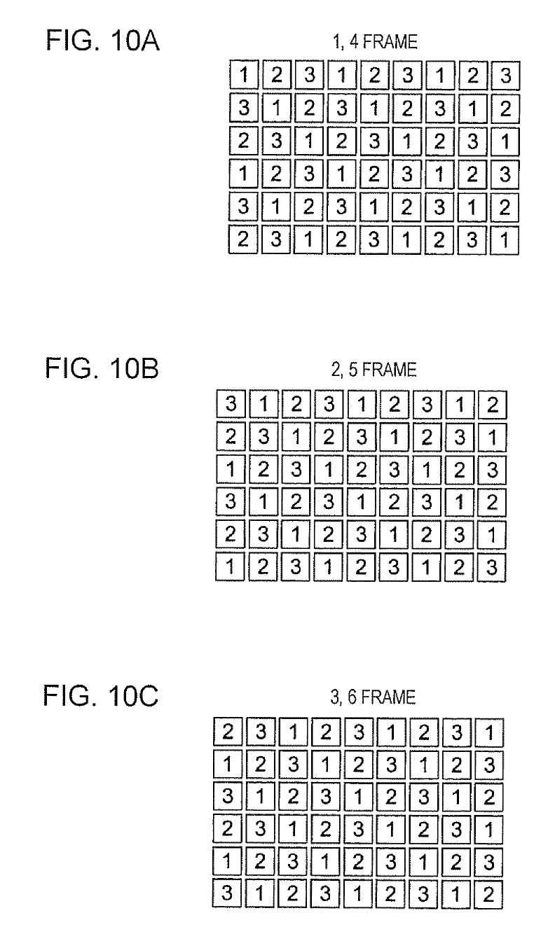

At this time, the influence caused by the difference of the pre-charge voltage is respectively shown in FIG. 10A as for the 1, 4 frames and in FIG. 10B as for the 2, 5 frames and in FIG. 10C as for the 3, 6 frames. In this manner, the influence caused by the difference of the pre-charge voltage is dispersed not only in spatial but also in temporal by performing rotation of pre-charge voltages also for every frame, so that the display unevenness can be further obscured.

The connection patterns of the selector 72 are rotated in the regular order, that is, in the order of (a)→(b)→(c). However, the pattern may be selected to any pattern in a random manner at the rate of ⅓ probability in the case of three phase development.

Further, the voltages Vp1(+), Vp2(+), Vp3(+) may be Vb(+)=Vp1(+), Vp3(+)=Vw(+). In this case, Vb(−)=Vp1(−), Vp3(−)=Vw(−).

In the case of three phase development, it is not necessary that all of the pre-charge voltages of the data lines 114 of three columns belonging to one block are different, and it is required that not less than two of the voltages are different. Accordingly, for example, the voltages may be Vp1(+)=Vp2(+)≠Vp3(+), Vp1(−)=Vp2(−)≠Vp3(−).

In the embodiment described above, three columns of data lines 114 are assembled in one block and the data signals Vid1 to Vid3 distributed/converted to three channels are sampled to the three columns of the data lines 114 belonging to one block. However, the distribution number and the number of the data lines to which the voltages are simultaneously applied (that is, the column number of the data lines constituting one block) is not limited to “three” and it is only required that the number is not less than “two”.

In the embodiment described above, a normally white mode is exemplified in which white display is performed during the voltage effective value between the counter electrode 108 and the pixel electrodes 118 are small. However, a normally black mode may be employed in which black display is performed.

In addition, although a transmissive type is exemplified for the electro optical device 10 of the embodiment, a reflective type may be employed. Further, in the above described embodiment, TN type liquid crystal is used. However, liquid crystal of bi-stabile type having memory property such as BTN (Bi-stable Twisted Nemmatic) type, ferroelectric type, liquid crystal of the GH (guest host) type in which a dye (guest) having anisotropy for absorption of visible light along the major axis direction and minor axis direction of molecules is dissolved in liquid crystal (host) with the constant molecular alignment to arrange the dye molecules in parallel with the liquid crystal molecules, or the like may be used.

Moreover, a configuration of vertical alignment (homeotropic alignment) may be adopted in which liquid crystal molecules are arranged in a direction vertical to both substrates when no voltage is applied, while liquid crystal molecules are arranged in a direction horizontal to both substrates when a voltage is applied. In addition, a configuration of parallel (horizontal) alignment (homogeneous alignment) may be adopted in which liquid crystal molecules are arranged in a direction horizontal to both substrates when no voltage is applied, while liquid crystal molecules are arranged in a direction vertical to both substrates when a voltage is applied. In this manner, various liquid crystal and alignment system can be applied to the invention.

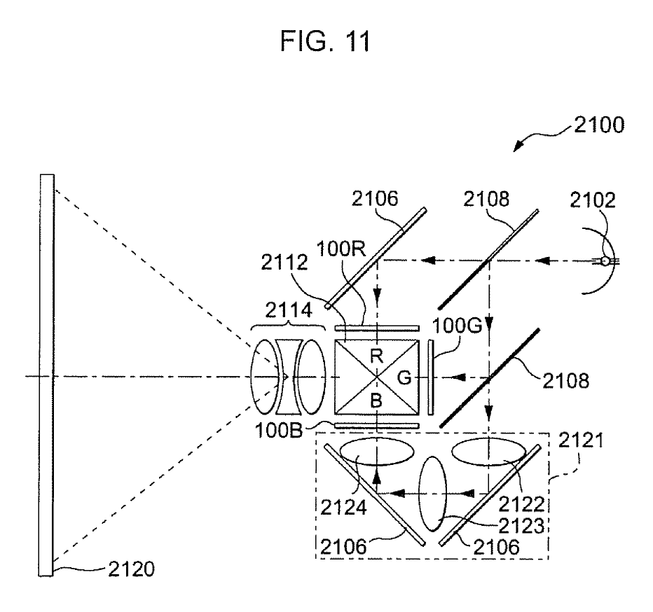

Next, as an example of an electronic apparatus using the electro optical device according to the embodiment described above, a projector using a display panel 100 of the liquid crystal device 10 as a light valve will be described. FIG. 11 is a plan view illustrating a configuration of the projector.

As shown in FIG. 11, within the projector 2100 is arranged a lamp unit 2102 comprising a white light source such as a halogen lamp. Projection light projecting from the lamp unit 2102 is divided into three red (R), green (G) and blue (B) primary colors by three mirrors 2106 and two dichroic mirrors 2108, which are arranged within the projectors 2100. The three primary colors are guided to light valves 100R, 100G and 100 corresponding to the primary colors, respectively. Since the blue (B) light has a relatively long optical path as compared to the red (R) and green (G) light, it is guided via a relay lens system 2121 comprising an entrance lens 2122, a relay lens 2123, and an exit lens 2124 in order to prevent a light loss.

Here, the light valves 110R, 100G and 100 have the same configuration as the liquid crystal panel 100 in the above embodiment and are driven by image signals corresponding to R, G and B colors, respectively, which are supplied from a control circuit (not shown in FIG. 11). That is, three electro optical devices containing the display panel 100 are provided in the projector 2100 so as to correspond with each color of R, G, B and the image data corresponding to each cooler of R, G, B is respectively supplied.

Light modulated by the light valves 100R, 100G and 100B is incident into a dichroic prism 2112 in three directions. In the dichroic prism 2112, the red (R) and blue (B) light is refracted by 90 degrees, while the green (G) light goes straight. Accordingly, after images having respective colors are combined, a color image is projected onto a screen 2120 by a projection lens 2114.

In addition, since light corresponding to the R, G and B primary colors is incident into the light valves 100R, 100G and 100B by the dichroic mirrors 2108, there is no need to provide color filters. In addition, since a transmission image of the light valve 100G is projected as it is while transmitted images of the light valves 100R and 100B are projected after being reflected by the dichroic prism 2112, a horizontal scan direction by the light valves 100R and 100B is opposite to a horizontal scan direction by the light valve 100G to display left and right inverted images.

Further, in addition to the projector 2100 described with reference to FIG. 11, the electronic apparatus includes a television, a view finder type or monitor direct-view type video tape recorder, a car navigator, a pager, an electronic organizer, a calculator, a word processor, a workstation, a video telephone, a POS terminal, a digital still camera, a cellular phone, an apparatuses equipped with a touch panel, and the like. It goes without saying that the electro optical device according to the invention can be applied to the various electronic apparatuses.

The entire disclosure of Japanese Patent Application No. 2007-083697, filed Mar. 28, 2007 is expressly incorporated by reference herein.

What is claimed is:

1. A driving method of an electro optical device including
rows of scanning lines,
“m” image signal lines to which a data signal is supplied,
columns of data lines blocked into blocks of “m” columns that correspond to the “m” image signal lines,
a scanning line driving circuit that applies a selection voltage for a period to one scanning line at a time in a predetermined order to select each scanning line in the predetermined order,
a block selecting circuit that selects the blocks of “m” columns in a predetermined order over the period in which the selection voltage is applied to one of the scanning lines,
sampling switches provided to each of the columns of data lines, each of the sampling switches controlling electrical connection between the corresponding image signal line and data line, and
pixels corresponding to intersections of the rows of scanning lines and the columns of data lines, each pixel is set to a gradation corresponding to a data signal sampled to the data line when the selection voltage is applied to the scanning line, the driving method comprising:
pre-charging the “m” columns of data lines belonging to each block to at least two different voltages before selecting the block; and
switching the combination of the at least two different voltages pre-charged to the “m” columns of data lines belonging to each block each time a scanning line is selected.

2. The driving method of an electro optical device according to claim 1, wherein rotation is performed to the combination of the voltages pre-charged to the “m” columns of data lines in a predetermined order for each time the scanning line is selected.

3. The driving method of an electro optical device according to claim 1, wherein rotation is performed to the combination of the voltage pre-charged to the “m” columns of data lines in a predetermined order for ever frame and for each time the scanning line is selected.

4. An electro optical device, comprising:
rows of scanning lines;
“m” image signal lines to which a data signal is supplied;
columns of data lines blocked into blocks of “m” columns that correspond to the “m” image signal lines;
a scanning line driving circuit that applies a selection voltage for a period to one scanning line at a time in a predetermined order to select each scanning line in the predetermined order;
a block selecting circuit that selects the blocks of “m” columns in a predetermined order over the period in which the selection voltage is applied to one of the scanning lines;
sampling switches provided to each of the columns of data lines, each of the sampling switches controlling electrical connection between the corresponding image signal line and data line;
pixels corresponding to intersections of the rows of scanning lines and the columns of data lines, each pixel is set to a gradation corresponding to a data signal sampled to the data line when the selection voltage is applied to the scanning line;
a pre-charge circuit that sets the voltage of the “m” columns of data lines belonging to each block to at least two different voltages before selecting the block; and
a selector that switches the combination of the at least two different voltages pre-charged to the “m” columns of data lines belonging to each block each time a scanning line is selected.

5. An electronic apparatus comprising the electro optical device according to claim 4.
